(19) United States
(12) Patent Application Publication
(10) Pub. No.: US 2025/0245733 A1
(43) Pub. Date: Jul. 31, 2025

(54) VIRTUAL TRYOUT EFFECT PRESENTATION METHOD FOR COMMODITY, AND ELECTRONIC DEVICE

(71) Applicant: Hangzhou Alibaba International Internet Industry Co., Ltd., Hangzhou (CN)

(72) Inventors: Wenbo YANG, Hangzhou (CN); Changyuan YANG, Hangzhou (CN); Kuilong LIU, Hangzhou (CN); Pengxin ZHAN, Hangzhou (CN); Bo MEI, Hangzhou (CN); Yicun ZHUANG, Hangzhou (CN); Gaige WANG, Hangzhou (CN)

(21) Appl. No.: 19/087,351

(22) Filed: Mar. 21, 2025

Related U.S. Application Data
(63) Continuation of application No. PCT/CN2023/133129, filed on Nov. 22, 2023.

(30) Foreign Application Priority Data
Nov. 30, 2022 (CN) 202211529325.X

(51) Int. Cl. G06Q 30/0601; G06T 15/04; G06T 15/20; G06V 10/26; G06V 10/44; G06V 10/80; G06V 40/10

(52) U.S. Cl. CPC G06Q 30/0643; G06Q 30/0623; G06T 15/04; G06T 15/205; G06V 10/26; G06V 10/44; G06V 10/80; G06V 40/10

(57) ABSTRACT

A virtual tryout effect presentation method for a product, and an electronic device are provided. The method includes: activating an image acquisition device of a terminal device to obtain hand images of a target user in a plurality of different hand postures in response to a request for a virtual trial of a product initiated by the target user through the terminal device; creating a 3D hand model of the target user according to the hand images; rendering and displaying the hand 3D model in a target interface, and providing information of selectable products; and in response to a selection result of a target selectable product, matching a 3D model corresponding to the target selectable product to a target position in the 3D hand model of the target user for display to show a display effect of virtual trial of the target selectable product through the hand 3D model.

### CROSS REFERENCE TO RELATED PATENT APPLICATIONS

This application claims priority to and is a continuation of PCT Patent Application No. PCT/CN2023/133129 filed on 22 Nov. 2023, and is related to and claims priority to Chinese Application No. 202211529325.X, filed on 30 Nov. 2022 and entitled “Virtual Tryout Effect Presentation Method for Commodity, and Electronic Device,” which are incorporated herein by reference in their entirety.

### TECHNICAL FIELD

The present disclosure relates to the field of virtual tryout technologies, and in particular to methods for presenting virtual tryout effects of commodities and electronic devices.

### BACKGROUND

With the rise of the concept of the metaverse (a virtual world built by humans using digital technology that maps or transcends the real world and can interact with the real world), the demands and services for people, goods, and places to enter the metaverse are increasing day by day. For example, some applications can provide users with intelligent “nail art” functions, that is, users can view the trial effects of various “nail art” products on their fingernails through mobile terminal devices, such as mobile phones.

In order to achieve the above purpose, existing technologies usually implements it through AR (Augmented Reality), that is, in a process of filming a user's hand through a terminal device such as a mobile phone, a position of a nail is identified from a real-time frame of a collected video, and a nail picture is attached to the position of the nail in such video frame for display, so as to present a trial effect of a specific “nail art” product by the user. However, in this method, since it is necessary to identify and track the position and the posture, etc., of the nail in video frames in real time when the user moves or rotates his/her hand to change his/her posture to view more “nail art” effects, and a part of image corresponding to the nail constitutes a relatively small proportion in the video frames, the difficulties of identification and tracking become greater. Therefore, it may cause problems such as inaccurate pasting of the “nail art” picture, affecting the effect of presentation. This is especially true when the speed of moving or rotating is relatively high, and delay, un-smoothness or deformation effects will appear. In addition, the “nail art” picture itself is usually a 2D picture, lacking thickness information, so that the effect after attachment does not look real enough, and the user experience is not good.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides a method and an electronic device for presenting effects of virtual trial of products, which can improve the trial effects of the products in C-end consumption scenarios.

The present disclosure provides the following solutions.

A method for presenting an effect of a virtual trial of a product, includes:
activating an image acquisition device of a terminal device to obtain hand images of a target user in a variety of hand postures in response to a request for a virtual trial of a product initiated by the target user through the terminal device;
creating a 3D hand model of the target user according to the hand images;
rendering and displaying the hand 3D model in a target interface, and providing information of selectable products; and
in response to a selection result of a target selectable product, matching and displaying a 3D model corresponding to the target selectable product at a target position in the 3D hand model of the target user to show a display effect of virtual trial of the target selectable product through the hand 3D model.

Creating the 3D hand model of the target user according to the hand images includes:
creating a 3D basic hand model of the target user according to the hand images, and obtaining a hand texture map of the target user; and
attaching the hand texture map to the hand 3D base model to generate the hand 3D model of the target user.

Creating the 3D basic hand model of the target user according to the hand images includes:
determining information of a hand contour from the hand images;
determining a target standard hand 3D basic model that satisfies a condition of similarity with the hand contour from a plurality of pre-established standard hand 3D basic models, wherein the standard hand 3D basic model is a parameterized model; and
adjusting key point parameters in the target standard hand 3D basic model according to the information of the hand contour to generate the hand 3D basic model of the target user.

Obtaining the hand texture map of the target user includes:
identifying and segmenting local images of multiple texture map surfaces from the hand images according to preset hand texture mapping style information; and
generating a complete hand texture map by fusing the local images of the multiple texture map surfaces.

The hand images include: a plurality of hand pictures obtained by respectively collecting hand images of the target user in the variety of hand postures.

The variety of hand postures include a first hand posture and a second hand posture. The first hand posture and the second hand posture respectively correspond to a palm and a back of the hand facing the image acquisition device when each finger is naturally extended, so that the first hand image and second hand image that are captured simultaneously include an image of the palm, and images of a palm surface and a back surface of each finger.

Obtaining the hand texture map of the target user includes:
identifying and segmenting images of the palm, and the palm surface and the back surface of each finger from the first hand image and the second hand image according to the preset hand texture map style information;
simulating images of a left side and a right side of each finger according to the images of the palm, and the palm surface and the back surface of each finger; and
generating a complete hand texture map by fusing the images of the palm, and the palm surface and the back surface of each finger, as well as the images of the left side and the right side of each finger.

The variety of hand postures further include: a third hand posture and a fourth hand posture.

The third hand posture includes: bringing a thumb and an index finger together toward a palm when all fingers are naturally spread out, so that the fingers are staggered in sequence in a front-back direction of a side, and one side of the hand is facing the image acquisition device, so that a third hand image captured also includes a side image of each finger on the side.

The fourth hand posture includes: on a basis of the third hand posture, keeping a state of each finger unchanged, and facing the other side of the hand to the image acquisition device, so that a fourth hand image captured also includes a side image of each finger on the other side.

The hand images include: a hand movement video obtained by capturing images during a process of rotating a wrist joint from a first angle to a second angle while keeping a hand posture of five fingers naturally spread out, wherein a difference between the second angle and the first angle is greater than 180 degrees.

The hand movement video includes a plurality of image frames corresponding to a process of rotating a part corresponding to a nail from a front view/a side view to the side view/the front view.

The method further comprises:
obtaining curvature information of the nail from the plurality of image frames to optimize key point parameters of the part corresponding to the nail in the hand 3D model.

The target selectable products include manicure products, 3D models corresponding to the target selectable products are parameterized models, the hand 3D basic model includes a nail 3D basic model.

Matching and displaying the 3D model corresponding to the target selectable product at the target position in the 3D hand model of the target user includes:
after adjusting key point parameters of a 3D model corresponding to a manicure product according to the nail 3D basic model, matching the model to a nail position in the hand 3D model of the target user for display.

Creating the nail 3D basic model in the following way:
determining information of respective nail contours corresponding to a plurality of fingers from the hand images;
determining, from a plurality of pre-established standard nail basic 3D models, a target standard nail basic 3D model having a degree of similarity with the nail contours satisfying a condition, wherein the standard nail basic 3D models are parameterized models; and
adjusting key point parameters in the target standard nail basic 3D model according to the information of the nail contours to generate the nail 3D basic model, the nail 3D basic model being used to align and fit onto the hand 3D basic model.

The method further includes:
providing candidate placement posture information about the hand 3D model so as to present the display effect of the target selectable product for trial use under a selected placement posture.

An apparatus for presenting an effect of a virtual trial of a commodity, includes:
a hand image acquisition unit, configured to activate an image acquisition device of a terminal device to obtain hand images of a target user in a variety of hand postures in response to a request for a virtual trial of a product initiated by the target user through the terminal device;
a hand 3D model creation unit, configured to create a 3D hand model of the target user according to the hand images;
a hand 3D model and selectable product display unit, configured to render and display the hand 3D model in a target interface, and providing information of selectable products; and
a trial effect display unit, configured to match and display a 3D model corresponding to the target selectable product at a target position in the 3D hand model of the target user to show a display effect of virtual trial of the target selectable product through the hand 3D model.

A computer-readable storage medium stores a computer program, which, when executed by a processor, implements the steps of any of the methods described above.

An electronic device includes:
one or more processors; and
a memory associated with the one or more processors, the memory being configured to store program instructions, wherein the program instructions, when read and executed by the one or more processors, execute the steps of any of the methods described above.

According to specific embodiments provided in the present disclosure, the present disclosure discloses the following technical effects:

Through the embodiments of the present disclosure, after a target user initiates a request for a virtual trial of a product through a terminal device, an image acquisition device of the terminal device can be started to obtain hand images of the target user in a variety of hand postures. In other words, the user only needs to make a few hand postures, and corresponding hand images can be obtained through the current terminal device. Therefore, it is suitable for implementation in C-end consumption scenarios. Afterwards, a 3D hand model of the target user can be created based on the hand images. The 3D hand model can be rendered and displayed in a target interface, and information on selectable products can be provided. After the user selects a target product, a 3D model corresponding to the target product can be matched to a target position in the 3D hand model of the target user for display, so as to show a display effect of a virtual trial of the target product through the 3D hand model. In this way, the 3D hand model created in real time for the target user can be used to show the virtual trial effect of the product. This thereby avoids situations such as “not sticking accurately”, etc., that occur when changing a hand posture during the trial of products such as manicure, etc.

Apparently, any product implementing the present disclosure does not necessarily need to achieve all of the advantages described above at the same time.

### BRIEF DESCRIPTION OF THE DRAWINGS

In order to more clearly illustrate the technical solutions of the embodiments of the present disclosure, drawings used in the embodiments will be briefly introduced below. Apparently, the drawings described below are only some embodiments of the present disclosure. For one of ordinary skill in the art, other drawings can be obtained based on these drawings without making any creative effort.

FIG. 1 is a schematic diagram of a system architecture provided by the embodiments of the present disclosure.

FIG. 2 is a flowchart of a method provided by the embodiments of the present disclosure.

FIG. 3 is a schematic diagram of a first method of collecting hand images provided by the embodiments of the present disclosure.

FIG. 4 is a schematic diagram of a second method of collecting hand images provided by the embodiments of the present disclosure.

FIG. 5 is a schematic diagram of an actual acquisition effect of the second method of collecting hand images provided by the embodiments of the present disclosure.

FIG. 6 is a schematic diagram of a third method of collecting hand images provided by the embodiments of the present disclosure.

FIG. 7 is a schematic diagram of a virtual trial effect provided by the embodiments of the present disclosure.

FIG. 8 is a schematic diagram of an apparatus provided by the embodiments of the present disclosure.

FIG. 9 is a schematic diagram of an electronic device provided by the embodiments of the present disclosure.

### DETAILED DESCRIPTION

In combination with the drawings in the embodiments of the present disclosure, the technical solutions in the embodiments of the present disclosure will be clearly and completely described below. Apparently, the described embodiments represent only part and not all of the embodiments of the present disclosure. Based on these embodiments in the present disclosure, all other embodiments obtained by one of ordinary skill in the art belong to the scope of protection of the present disclosure.

In the embodiments of the present disclosure, in order to improve the trial effects of manicure products, a method of XR (Extended Reality) can be used to realize a digital restoration of a hand of a user (which mainly refers to a C-end user, such as a consumer, etc., in the embodiments of the present disclosure). In other words, a user's hand 3D basic model (white model) can be constructed in real time according to some information of the user's real hand, and a hand texture is attached to the hand 3D basic model, so as to obtain a complete hand 3D model, and make it look like the user's real hand. Based on such hand 3D model, the trial effects of manicure products are then displayed, which include changing a variety of postures, changing a variety of different manicure products, etc., to view different trial effects. Since the hand 3D model is used for trying out a manicure product, respective position information of each point of the hand 3D model in various postures can be saved in the system in advance. Therefore, in a process of changing the posture, information, such as 3D coordinates of each point, etc., can be quickly determined, and a nail 3D model can then be attached according to information, such as 3D coordinates f a specific target point, etc. Therefore, there is no problem of inaccurate attachment. In addition, since the hand 3D model includes 3D coordinate information of each target point, such 3D coordinate information can reflect the curvature of a nail, etc. Therefore, in a process of attaching a nail 3D model based on such 3D coordinate information, the realness of the trial effect can be improved.

When building a 3D model of a user's hand, it can be divided into two steps: modeling and texture mapping. A modeling process is to complete a creation of a 3D basic model (usually referred to as a white model). The 3D basic model is mainly used to describe information, such as 3D coordinates of each point in the model, etc., and a default texture map is gray or white in color, etc. In order to make a specific 3D model to achieve digital restoration more realistically, that is, to look more like a user's own hand, it is also necessary to perform texture mapping of the basic model. A texture mapping process is a process of giving a soul to a model. In layman's terms, texture mapping can be understood as “painting the skin”. After a basic model is created, the outline of the hand, the thickness of the palm, the lengths and thicknesses of the fingers, etc., can all be determined. Then, since the hand does not have a texture map, a skin is provided thereto. The model is attached with this skin, and the color and the texture presented by the model will be closer to a real hand, rather than gray or white. Therefore, in a process of building a 3D hand model, obtaining a texture map of a hand is also a relatively important link.

In traditional methods of digitally restoring a target object, obtaining a texture map of a hand is usually completed while a 3D basic model is established. For example, in a method of modeling through radar, it is usually necessary to fix a target object at a certain position, and then use the radar to emit photons to scan it. According to the time taken for the photon to hit a certain point on the surface of the target object and then return, the position of the point hit by the photon is calculated. According to position information of a number of such points, a creation of a 3D basic model of the target object can be completed. At the same time, the target object can also be photographed from multiple angles by a camera, etc., and a texture map of the target object can be obtained from these multi-angle pictures that are taken, so as to be attached to the 3D basic model. Alternatively, a 360-degree shooting of the target object can be performed by rotating the camera around the target object, and the 3D basic model of the target object can be constructed based on multiple photos obtained from multiple angles. A complete texture map of the target object can be obtained at the same time, and the texture map is attached to the basic model to generate a complete 3D model.

In the above implementation, whether a radar device is scanning a target object or a camera is used to perform a 360-degree shooting of the target object, there is a strict requirement that the target object must be fixed. Even if the target object shakes or sways slightly, a restoration of a 3D model constructed thereby will be poor. In addition, a specific scanning process is usually very time-consuming. Therefore, the above-mentioned solutions of the existing technologies are usually more suitable for scenarios of non-real-time data restoration. In other words, the generation of 3D models can be completed offline in advance, and then published online for performing a variety of different interactions.

However, in the embodiments of the present disclosure, since it is necessary to digitally restore a user's hand in real time, it is obviously inappropriate if a modeling process takes too long. In addition, in C-end consumption scenarios, users usually complete digital restoration of their hands in a self-service manner. Specifically, a user is required to hold a mobile terminal device, such as a mobile phone, etc., using one hand, and scan his/her other hand. In this state, it may be difficult for the user to complete a process, such as 360-degree shooting, etc., alone. Furthermore, it is almost impossible to keep the hands completely still and not moved during a long scanning or shooting process. The existence of the above various types of situations makes it impossible to implement methods of creating a 3D basic model of a hand in the existing technologies. Accordingly, it is impossible to obtain a texture map of a hand in existing processes of 3D basic model creation. Apparently, in some existing technologies, in order to keep a hand still, a device configured to carry or clamp a hand can be provided. Then, another person can hold a photographic device to complete 360-degree shooting around the fixed hand, or a pre-setup photographic device can be used to perform 360-degree shooting around the fixed hand, etc. However, in C-end consumption scenarios, users usually use their own mobile phones or other terminal devices to perform operations, and prefer to complete them by themselves. Therefore, the above solution is not suitable for C-end consumption scenarios.

In view of the above situation, the embodiments of the present disclosure provide implementation solutions that are more suitable for establishing a 3D hand model in C-end consumption scenarios. In this way, a user can be required to collect hand images under a variety of hand postures, and a 3D basic hand model can then be established based on these hand images. At the same time, a texture map of the user's hand can also be obtained, and then the hand's texture map can be attached to the 3D basic hand model to generate a specific 3D hand model. In other words, in the embodiments of the present disclosure, there is no need to fix or clamp the user's hand. There is also no need for the help of other people or special photographic device. Rather, various hand postures can be changed directly as required, and images can be captured and collected under these hand postures using a terminal device, such as a current mobile phone, etc., to complete the creation of a 3D hand model. After that, the 3D hand model can be rendered and displayed in a target page of the current terminal device, and trial effects of products, such as manicure, etc., can be provided based on the 3D hand model.

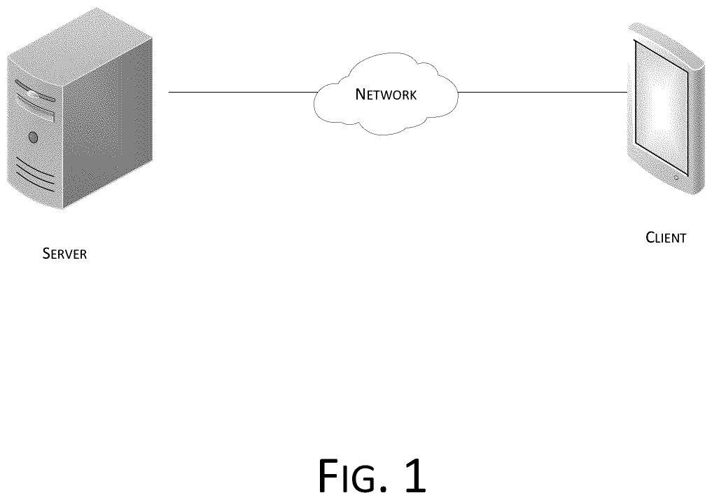

From the perspective of system architecture, the embodiments of the present disclosure mainly provide C-end users with applications or services for trial use of products in categories such as manicures. Specifically, from the perspective of product form, referring to FIG. 1, an independent application may be provided, or a small program or a light application may be provided in an existing application. Alternatively, a trial function module may be provided in some related products, and so on. For example, a “manicure”-related small program may be provided in a payment application. The function of the small program is to provide a trial use of a variety of manicure products. A user can choose a manicure product that suit him/her based on trial effects thereof and place an order, etc. Alternatively, a “trial” module may be provided in a product information service system, and the “trial” module may include trial uses of manicure products published in the system. Alternatively, a “trial” function option may be provided in pages such as relevant detail pages of the manicure products in the product information service system. In this way, when a user browses a detail page of such a product, he/she can use this option to try out the manicure product associated with the detail page, and can also compare between multiple different SKUs associated with that product, etc. In a process of trying out manicure products in the above-mentioned scenarios, this involves real-time digital restoration of a user's hand, that is, a real-time creation of a 3D hand model. At this time, a client of the above-mentioned application or applet or functional module can start an image acquisition apparatus of a terminal device, and provide prompt information about a plurality of different hand postures to obtain hand images of a target user in the plurality of different hand postures. In this way, a specific 3D hand model can be generated based on these hand images, and a manicure product can then be tried out based on the 3D hand model.

In this way, although the trial of a manicure product is not directly based on a real hand in video frames, since a specific hand 3D model is a model created based on hand features of the current user, it can have a high degree of restoration of the user's real hand. Therefore, it can also present visual effects that the user personally tries out the manicure product. At the same time, this trial process based on a hand 3D model can be changed into a variety of different postures for trial, and will not cause inaccurate sticking due to flipping or movement of the hand during a posture change. In addition, since the hand 3D model has 3D coordinate information of key points of the hand, the trial effects presented after the manicure product is attached to a nail is also more realistic. Furthermore, in the solutions for creating a hand 3D model provided by the embodiments of the present disclosure, the user only needs to change a number of hand postures and obtain images in a self-service manner to complete the creation of the hand 3D model, without the need to fix the hand and perform processes, such as a 360-degree shooting, etc. So, it is more suitable for implementation in C-end consumption scenarios.

Specific implementation solutions provided in the embodiments of the present disclosure are described in detail below.

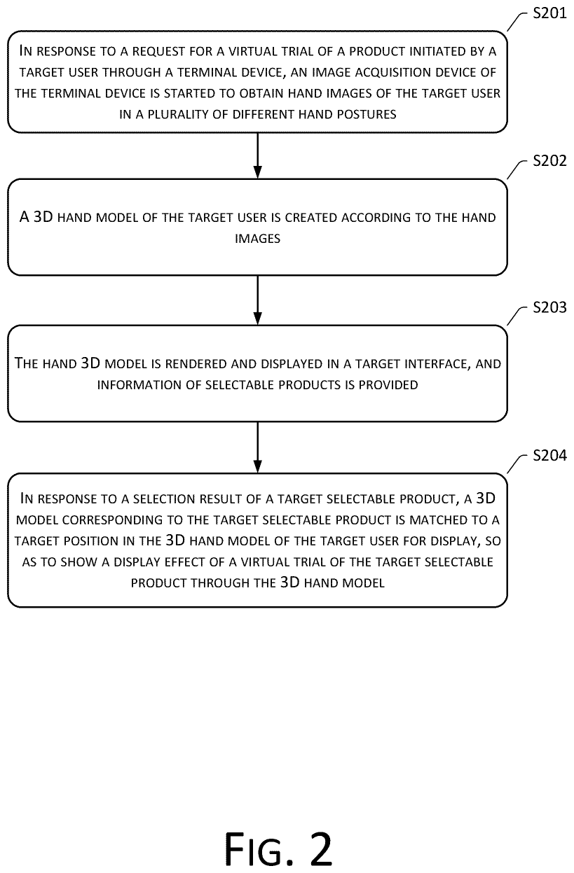

First, from the perspective of a client as described above, the embodiments of the present disclosure provide a method for displaying effects of a virtual trial of a product. Referring to FIG. 2, the method may specifically include:

S201: In response to a request for a virtual trial of a product initiated by a target user through a terminal device, an image acquisition device of the terminal device is started to obtain hand images of the target user in a plurality of different hand postures.

In the embodiments of the present disclosure, applications, applets, or functional modules, etc., related to virtual trial of products can be provided to C-end users. Specific applications, applets, or functional modules, etc., can be run in terminal devices such as mobile phones of the users, so that the users can initiate requests for virtual trial of products through specific terminal devices. Afterwards, in the embodiments of the present disclosure, an image acquisition device of a terminal device can be activated to obtain hand images of a target user in a variety of hand postures. A number of specific hand postures exist, as long as the contour of a hand can be determined from these hand images for creating a 3D basic model of the hand, and as many local images of multiple texture map surfaces (a complete hand texture map is a three-dimensional surface, and for ease of implementation, the three-dimensional surface can be split into multiple two-dimensional map surfaces) as possible can be obtained for establishing a hand texture mapping.

There will be some more preferred hand postures. When a user's hand posture is relatively standard, accurate, and in place, it will be helpful to improve the realness of a corresponding hand 3D model. To this end, in an optional method, prompt information for a variety of different hand postures can also be provided. In this way, the current target user only needs to change to different hand postures according to the prompt information, and hand images of the target user in the different hand postures are collected through an image acquisition device of his/her terminal device in a self-service manner. Such prompt information can exist in a form of text, or a prompt can also be given in a form of a hand outline diagram in a specific posture. As such, the user can only need to make a corresponding hand posture according to specific prompt information, while pressing a photo capture button with one hand holding the terminal device for taking a photo. Since multiple hand postures can be provided in the embodiments of the present disclosure, they may be prompted to a user one by one to guide the user to complete an acquisition of corresponding hand images.

Specifically, in specific implementations of the embodiments of the present disclosure, the hand images obtained can be: multiple hand photos obtained by respectively collecting hand images of the target user in the plurality of different hand postures. That is, the creation of the hand 3D model can be completed through photos, such as multiple hand photos, etc.

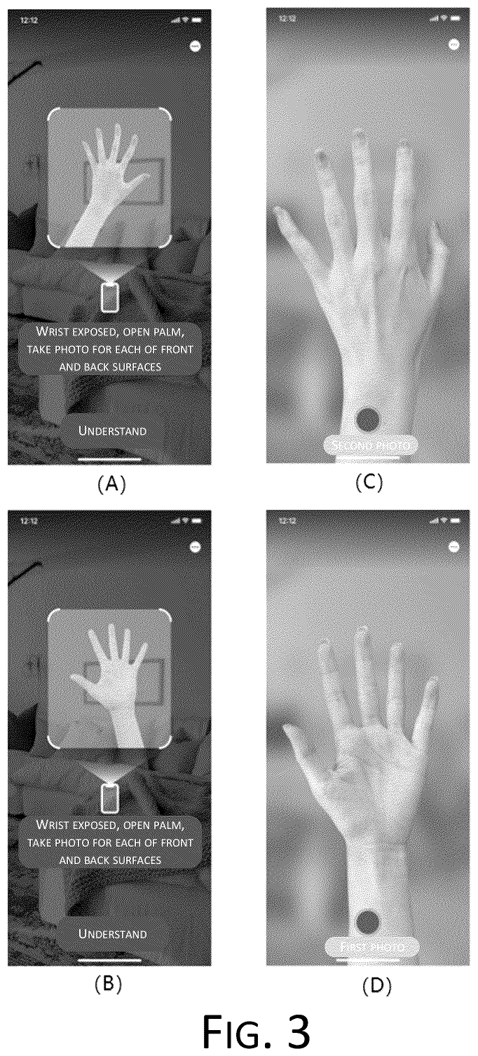

In one method, the plurality of different hand postures may include a first hand posture and a second hand posture, wherein the first hand posture and the second hand posture correspond to the palm and the back of the hand facing the image acquisition device respectively when each finger is naturally unfolded, so that a first hand image and a second hand image collected simultaneously include images of respective palm surfaces and back surfaces of the palm and each finger of the hand. In other words, in this method, the user only needs to make two hand postures and take respective photos, and these two photos can be used to complete the creation of the user's hand 3D model. In this method, the specific prompt information about the hand postures can be shown in FIGS. 3(A) and (B). Correspondingly, the user can stretch out one hand and make a corresponding hand posture in front of the lens of the image acquisition device of the terminal device, and then operate the terminal device with the other hand to perform an image capture action. For example, the corresponding first hand image and second hand image taken may be like the ones shown in FIGS. 3(C) and (D).

In the method as shown in FIG. 3 above, the user only needs to make two hand postures and take two photos. Therefore, the user's operating cost is very low, which is very conducive to implementations in C-end consumption scenarios. However, since only images of the front and the back of the palm and the fingers (corresponding to the palm and the back of the hand, respectively) can be obtained from the first hand image and the second hand image as described above, and images of the left and right sides of each finger and the side image of the palm are difficult to obtain directly from the images, this is not conducive to the generation of a hand texture map in the process of creating the 3D hand model.

Therefore, in an optional embodiment, the user can be prompted to perform two other hand postures, namely, a third hand posture and a fourth hand posture, based on the two hand postures shown in FIG. 3. The third hand posture may include: when each finger is naturally spread out, the thumb and the index finger are brought toward the palm, so that the fingers are sequentially staggered in the front to back direction of the side, and one side of the hand is facing the image acquisition device, so that the third hand image collected also includes side images of each finger on one side. The fourth hand posture may be: based on the third hand posture, the state of each finger is kept unchanged, and the other side of the hand is facing the image acquisition device, so that the fourth hand image collected also includes side images of each finger on the other side. In other words, in this method, the user needs to make four different hand postures and take four hand photos. In this method, more abundant hand information, especially the images of the left and right sides of the fingers and the palm, can be obtained with a small increase in the user's operating cost, so that the realness of the hand 3D model can be significantly improved.

It needs to be noted that in the third hand posture described above, since the thumb and the index finger are brought closer to the palm with the five fingers naturally spread out, the other fingers can remain naturally spread out during this process. However, since the base of each finger is connected by muscle tissues, a certain pulling force will be exerted on the other fingers during the process of the index finger moving closer to the palm. At this time, the other fingers can be naturally staggered a certain distance in the front to back direction of the side without the need for additional force. In this way, when the side of the hand faces the image acquisition device, images of the five fingers on one side can be obtained at the same time.

In the third hand posture, the degree to which the thumb and the index finger are close to the palm may affect the quality of the hand image that is captured. For example, if the thumb and the index finger are too close to the palm (i.e., the thumb and the index finger are too close), then the thumb and index finger may cause some mutual occlusion. If the thumb and the index finger are too far away from the palm, although the thumb and index finger may not cause mutual occlusion, the pulling force of the index finger on the other fingers may be insufficient, which results in insufficient separation of staggering between the other fingers in the front to back direction of the side, thereby affecting the integrity of the side images of the other fingers. In addition, if the user is not sure about the degree of closeness between the thumb and the index finger, it may be difficult to make the correct hand posture.

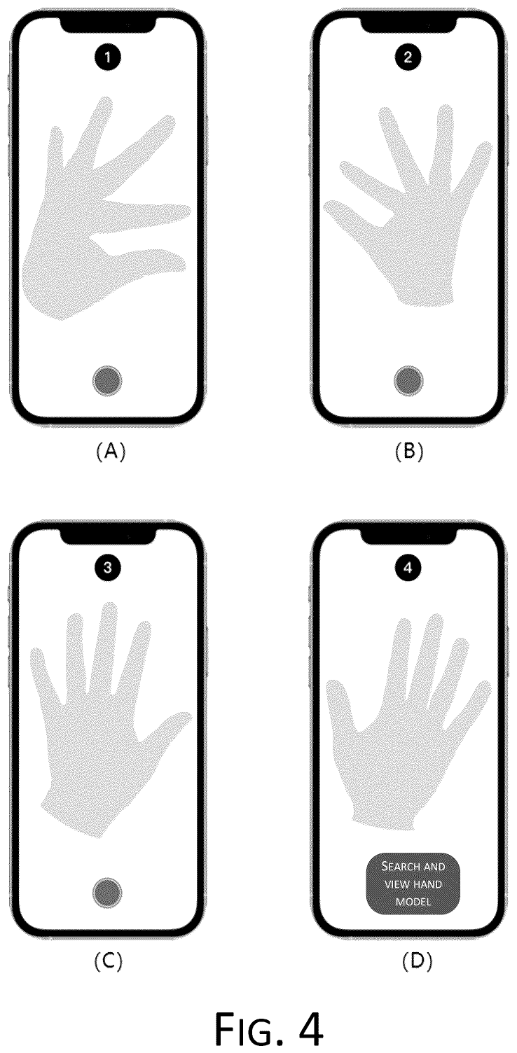

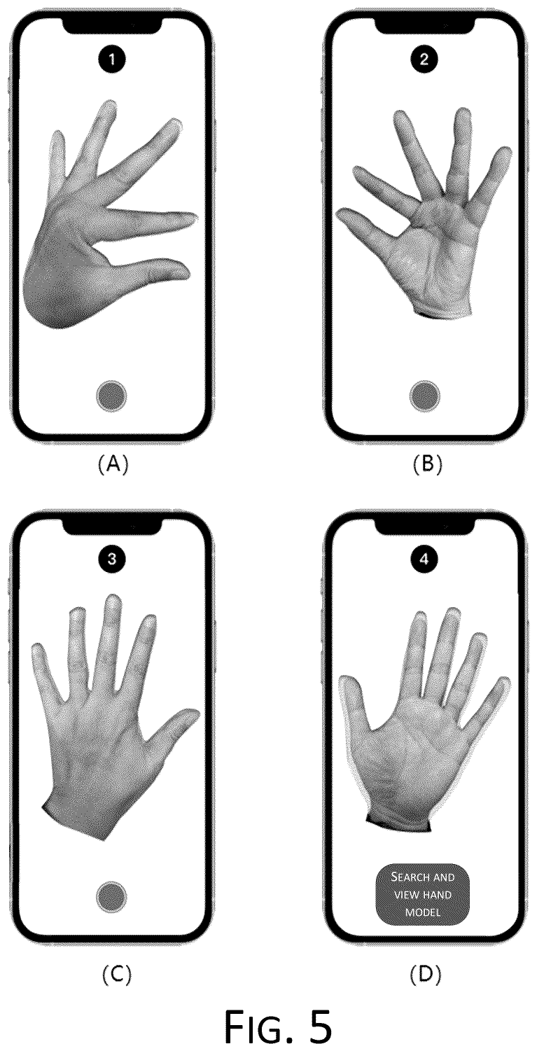

To this end, under a preferred embodiment, in order to make the separation of staggering between the fingers far enough in the third hand posture to avoid mutual occlusion, and to facilitate the user to determine to what extent the thumb and the index finger need to be brought together, more clear requirements can be made for the third hand posture. Specifically, the user can be required to bring the thumb and the index finger toward the palm so that the thumb and the index finger can be parallel or nearly parallel. For example, a specific third hand posture can be like the one as shown in FIG. 4(A). In this state, the separation of staggering between the fingers can be far enough, and it is also easier for the user to do such posture. Correspondingly, the third hand image obtained after the user takes a photo according to the third hand posture can be like the one as shown in FIG. 5(A).

Since only one side image of each finger can be collected in the third hand posture, the specific designated postures may also include a fourth hand posture. The fourth hand posture may be a posture that keeps the state of each finger unchanged on a basis of the third hand posture, while facing the other side of the hand to the image acquisition device, so that a fourth hand image collected also includes side images of the other side of each finger. For example, the fourth hand posture may be like the one as shown in FIG. 4(B). Correspondingly, the fourth hand image obtained after the user takes a photo according to the fourth hand posture may be like the one as shown in FIG. 5(B).

Through the third hand image and the fourth hand image as described above, the side images of the palm and each finger can be obtained. Combined with the first hand image and the second hand image obtained in the solutions shown in FIG. 3 (which can correspond to the postures shown in FIGS. 4(C) and (D) and the hand images shown in FIGS. 5(C) and (D)), images of the front and the back of the palm and the fingers can be obtained. Therefore, more images of a map surface can be obtained, so as to obtain a more complete hand texture map, thereby improving the realness of the hand 3D model.

The above-mentioned methods are all to obtain hand images by taking photos of a hand. In another method, the hand images can also be obtained by taking videos of the movement of the hand. Specific hand images can be a video of hand movement obtained by capturing and collecting images during a process of rotating a wrist joint from a first angle to a second angle with a hand posture of five fingers naturally spreading out, wherein a difference between the second angle and the first angle is greater than 180 degrees. It need to be noted here in the process of rotating the wrist joint, although the five fingers can always maintain a posture of naturally spreading out, since the angle of the wrist joint is constantly changing, each different angle can correspond to a different hand posture. Therefore, the video of hand movement obtained can also include hand images of the user in a variety of different hand postures.

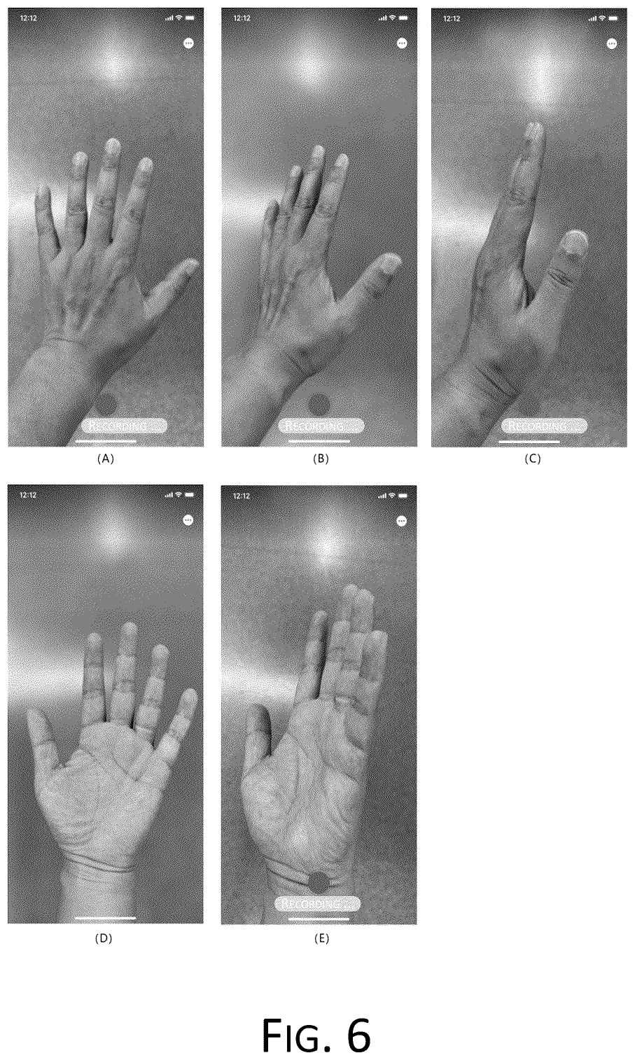

For example, as shown in FIGS. 6(A) to (E), the user can, under the guidance of prompt information, make a posture with five fingers naturally spreading out. First, the back of the hand can be facing upward and toward the lens of the image acquisition device, and the angle of the wrist joint in this state is called the first angle. Then, the fingers can be kept in the same state and the wrist joint can be rotated toward a direction away from the body. After the palm is rotated to become facing up and is continued to rotate until the rotation limit of the wrist joint is reached, the angle of the wrist joint in that state can be called the second angle. Since the rotation from the back of the hand facing up to the palm facing up is 180 degrees and the rotation continues afterward, the total rotation angle will be greater than 180 degrees. In this way, the video of hand movement captured in the process can include images of the front, the back and the sides of the palm and each finger as much as possible. In addition, in this way, since the hand movement video can record the process of the hand rotating from the front/side to the side/front, it is more conducive to restoring the curvature of the nails, etc. So, in a scene where the parts corresponding to the nails need to be more accurately digitally restored, it is more suitable to use this method to achieve it.

S202: A 3D hand model of the target user is created according to the hand images.

After obtaining the hand images of the target user in the plurality of different hand postures, a 3D hand model of the target user can be created based on the hand images. Specifically, when creating the 3D hand model of the target user, a 3D basic hand model of the target user can first be created based on the hand images, and a texture map of the hand of the target user can be obtained. The texture map of the hand is then attached to the 3D basic hand model to generate the 3D hand model of the target user.

Regarding the creation of a 3D basic model of a hand, since the embodiments of the present disclosure can be specifically applied to a real-time digital restoration of a user's hand and traditional methods of creating a 3D basic model may not be applicable to this scenario, a method for creating a hand's 3D basic model can also be provided in the embodiments of the present disclosure. Specifically, multiple standard 3D basic models of a hand can be created in advance according to common hand shapes, that is, these standard models are not created based on real hand information of a specific user, but are classified using hand shapes of a large number of users. More representative 3D basic models of the hand are then created based on these categories of hand shapes. These standard 3D basic models of the hand can be parametric 3D models, that is, key point parameters in the models can be adjusted. By changing parameters of some key points (including 3D coordinates, etc.), these standard 3D basic models of the hand can be fine-tuned to generate new 3D basic models of the hand.

In case when multiple standard 3D basic hand models are pre-established, contour information of the hand of the current target user can be directly determined from the hand images obtained above, and a target standard 3D basic hand model that satisfies a hand contour similarity condition with the current target user can then be selected from the multiple standard 3D basic hand models pre-established above. For example, a standard 3D basic hand model that is most similar to the contour of the hand of current target user can be selected. Afterwards, key point parameters in the target standard 3D basic hand model can be adjusted according to the contour information of the hand of the current target user to generate a first model. The first model can be closer to the actual hand shape of the current target user after further adjustment is performed on the target standard 3D basic hand model selected above, and the target user's hand 3D basic model can then be generated according to the first model.

Alternatively, in another way, taking into account of application scenarios such as trying out manicure products, a 3D model of a specific manicure product is mainly attached to the part corresponding to a nail, and nail shapes of different users are also different, if the nail is only regarded as part of the hand 3D model, the effects after attachment may not be good enough. Therefore, in order to further improve the realness after attachment, a separate nail 3D model can be established for the nail part, and the nail 3D model is then combined with the first model established above to generate a complete hand 3D model. In this way, when trying out a manicure product, the 3D model of the manicure product can be attached according to the specific nail 3D model part.

In specific implementations, multiple standard nail 3D basic models can also be created in advance for a plurality of common nail types (nail shapes, etc.), wherein a standard basic nail 3D model can include nail models corresponding to five fingers. Apparently, this type of standard basic nail 3D model can also be a parametric model, i.e., parameters such as 3D coordinates of some key points in the model can be adjusted.

In this way, after obtaining the hand images as described above, contour information of nails corresponding to multiple fingers can be determined therefrom. A target standard nail basic 3D model that meets conditions for similarity of nail contour with the current target user can then be determined from multiple pre-established standard nail basic 3D models. Key point parameters in the target standard nail basic 3D model can then be adjusted according to nail contour information of the current target user to generate a second model, and afterwards, the first model can be combined with the second model, i.e., each nail model in the second model is aligned and fitted to the first model, so as to generate a 3D basic model of the hand of the current target user.

It needs to be noted here that, when a 3D basic model of the hand is generated, especially when a more accurate 3D basic model of a nail is required, information about the curvature of the nail and other aspects can also be extracted from the hand images to create a more realistic nail model of the target user and improve the realness of trial effects of manicure products. In this case, specific hand images can be obtained preferentially in the manner as shown in FIG. 6. This is because, in the video of hand movement collected during rotation of the wrist joint, for the nail part, a process of rotation from a horizontal view to a side view (relative to the lens of the image acquisition device) or from the side view to the horizontal view can be manifested. In this process of rotation, the algorithm can more accurately identify the curvature information of the nail.

There are multiple specific methods for obtaining the texture map of the hand of the target user. For example, in one method, local images of multiple texture map surfaces can be identified and segmented from the hand images according to preset hand texture map style information, and then the local images of the multiple texture map surfaces are fused to generate a complete hand texture map. In other words, in order to facilitate identification of the texture map surfaces and subsequent fusion processing, the hand texture map style information can be provided in advance, and multiple texture map surfaces can be defined in the hand texture map style information, for example, the front surface and the back surface of the palm, the front surface and the back surface of each finger, the left and right sides, etc. In this way, local images of multiple texture map surfaces can be identified and segmented from the hand images according to such style information.

Specifically, since there are many ways to obtain a hand image, the richness of information included in a specific hand image is different. For cases with low richness, it may be impossible to directly obtain part of a texture map surface. At this time, based on images of texture map surfaces that can be obtained, image processing technology can be used to predict or estimate images of other texture map surfaces, and thereby simulate the images of the other texture map surfaces and generate a complete hand texture map.

For example, in case of obtaining hand images as shown in FIG. 3, since there are only hand images of front and back surfaces of a hand, it may be difficult to directly obtain images of side surfaces of the fingers. In this case, images of palm and back surfaces of the palm and each finger can be first identified and segmented from the first hand image and the second hand image according to the preset hand texture map style information. Then, images of left and right side surfaces of each finger can be simulated according to the images of the palm and back surfaces of the palm and each finger. Finally, the images of the palm and back surfaces of the palm and each finger, as well as the images of the left and right side surfaces of each finger are fused together to generate a complete hand texture map.

If four hand images as shown in FIG. 5 are obtained according to the hand postures shown in FIG. 4, images of palm and back surfaces and left and right side surfaces of the palm and the fingers can be obtained directly from the hand images. Apparently, there may be incomplete images of side surfaces of some fingers in the hand images. For example, the side root of the ring finger may be partially blocked by the middle finger. At this time, this blocked part can also be generated by performing simulation based on other images that can be obtained through image processing technology, etc.

After the hand 3D base model is established and the complete hand texture map is obtained, the hand texture map can be attached to the hand 3D base model to generate a final hand 3D model.

It needs to be noted here that, in practical applications, after obtaining specific hand images, the client can also upload them to a server, and the server will create a specific hand 3D model, which is then returned to the client.

S203: The hand 3D model is rendered and displayed in a target interface, and information of selectable products is provided.

After the hand 3D model is generated, the hand 3D model can be rendered and displayed in an interface. In other words, after the user initiates a virtual trial request for a product through an application or mini program, and collects hand images as prompted, the user can view a creation result of the hand 3D model in an interface of the application or mini program.

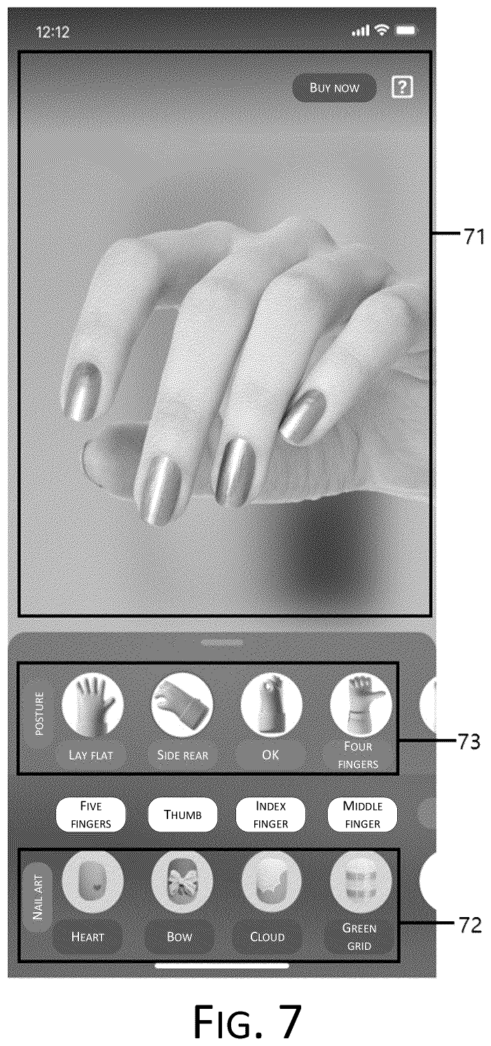

In addition, the information of selectable products can also be displayed in the interface that displays the hand 3D model. For example, a specifically generated hand 3D model can be like the one as shown at 71 in FIG. 7. If products to be currently tried out are manicure products, information of selectable manicure products, including representative pictures, etc., can also be displayed as shown at 72 in FIG. 7. In this way, the user can select a product of his/her interest for trial.

S204: In response to a selection result of a target selectable product, a 3D model corresponding to the target selectable product is matched to a target position in the 3D hand model of the target user for display, so as to show a display effect of a virtual trial of the target selectable product through the 3D hand model.

After the user selects a target product for trial, a 3D model corresponding to the target product can be matched to a target position in the 3D hand model of the target user for display. In other words, in the embodiments of the present disclosure, a specific target product can also have a corresponding 3D model. Moreover, under a preferred embodiment, the 3D model corresponding to the product can also be a parameterized model, i.e., parameters of some key points can also be adjusted to better match an actual situation of the 3D hand model of the specific user. For example, in specific implementations, parameters of corresponding key points in the 3D model corresponding to the product can be adjusted according to key point parameters at the target position in the 3D hand model of the specific user, so that the 3D model corresponding to the product can better fit the 3D hand model of the user to show a more realistic trial effect. For a manicure product, since the specific hand 3D model can also include a nail 3D model, therefore, key point parameters in a 3D model of the manicure product can also be adjusted according to key point parameters of the 3D nail model, so that the 3D model of the manicure product is more in line with the specific nail 3D model, and avoid an occurrence of a situation that the manicure product does not match the specific user's nail in terms of size, curvature, etc.

In an initial state, the hand 3D model can also have a default placement posture. Specifically, according to characteristics of a product that needs to be tried, a posture that is more suitable for reflecting the trial effect can be selected, etc. For example, if the product to be tried is a manicure product, the specific hand 3D model can adopt a placement posture as shown at 71 in FIG. 7, etc.

In addition, information of other candidate placement postures about the specific hand 3D model can also be provided, so that the user can choose to display the display effect of the target product for trial in other placement postures. For example, as shown at 72 in FIG. 7, a plurality of other selectable placement postures can also be provided, so that if the user needs to view trial effects in other postures, he/she can choose from these options. Furthermore, it is also possible to choose to display all trial effects on five fingers, or to display a trial effect of a certain finger alone, etc.

It needs to be noted that, in practical applications, the established 3D hand model can also be saved, so that the user can directly use the 3D hand model when trying other products at a later time.

In summary, through the embodiments of the present disclosure, after a target user initiates a request for a virtual trial of a product through a terminal device, an image acquisition device of the terminal device can be activated to obtain hand images of the target user in a variety of different hand postures. In other words, the user only needs to make a few hand postures and obtain corresponding hand images through the current terminal device. Therefore, it is suitable for implementation in C-end consumption scenarios. Afterwards, a 3D hand model of the target user can be created based on the hand images. The 3D hand model can be rendered and displayed in a target interface, and information of selectable products can be provided. After the user makes a selection of one of the target selectable products, a 3D model corresponding to the target selectable product can be matched to a target position in the 3D hand model of the target user for display, so as to show a display effect of the virtual trial of the target selectable product through the 3D hand model. In this way, the 3D hand model created in real time for the target user can be used to show the virtual trial effect of the product, so as to avoid a situation of “not sticking accurately”, and the like, that occurs during the trial of products such as manicure by changing the hand posture.

It needs to be noted that the embodiments of the present disclosure may involve the use of user data. In practical applications, user-specific personal data can be used in the solutions described herein within the scope permitted by applicable laws and regulations, subject to the requirements of applicable laws and regulations of the country where the user is located (for example, with the user's explicit consent, effective notification to the user, etc.).

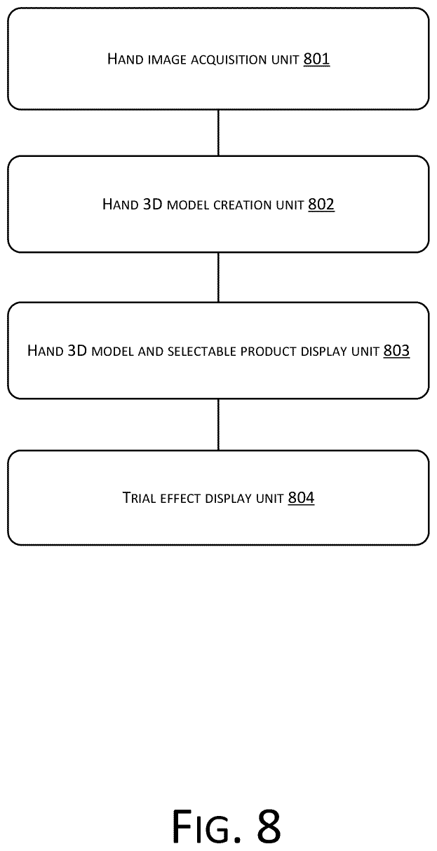

Corresponding to the aforementioned method embodiment, the embodiments of the present disclosure further provide an apparatus for presenting an effect of a virtual trial of a product. Referring to FIG. 8, the apparatus may include:
a hand image acquisition unit 801, configured to activate an image acquisition device of a terminal device to obtain images of a hand of a target user in a plurality of different hand postures in response to a request for a virtual trial of a product initiated by the target user through the terminal device;
a hand 3D model creation unit 802, configured to create a hand 3D model of the target user according to the images of the hand;
a hand 3D model and selectable product display unit 803, configured to render and display the hand 3D model in a target interface, and provide information of selectable products; and
a trial effect display unit 804, configured to match a 3D model corresponding to a target selectable product to a target position in the 3D hand model of the target user for display in response to a selection result of the target selectable product, so as to show a display effect of virtual trial of the target selectable product through the 3D hand model.

Specifically, the hand 3D model creation unit can be configured to:
create a 3D basic hand model of the target user according to the images of the hand, and obtain a hand texture map of the target user; and
attach the hand texture map to the hand 3D base model to generate the hand 3D model of the target user.

Specifically, when creating the 3D basic hand model, the hand 3D model creation unit can be configured to:
determine information of a hand contour from the images of the hand;
determine a target standard hand 3D basic model that satisfies a condition of similarity with the hand contour from a plurality of pre-established standard hand 3D basic models, wherein the standard hand 3D basic model is a parameterized model;
adjust key point parameters in the target standard hand 3D basic model according to the information of the hand contour to generate the target user's hand 3D basic model.

The hand 3D model creation unit can be specifically configured to obtain the hand texture map:
identifying and segmenting local images of multiple texture map surfaces from the images of the hand according to preset hand texture mapping style information; and
generating a complete hand texture map by fusing the local images of the multiple texture map surfaces.

The hand images include: a plurality of photos of the hand obtained by respectively collecting the images of the hand of the target user in the variety of different hand postures.

Specifically, the plurality of different hand postures includes a first hand posture and a second hand posture. The first hand posture and the second hand posture respectively correspond to a palm and a back of the hand facing the image acquisition device when each finger is naturally extended, so that the first hand image and second hand image that are captured simultaneously include an image of the palm, and images of a palm surface and a back surface of each finger.

At this time, the hand 3D model creation unit can be specifically configured to:
identify and segment images of the palm, and the palm surface and the back surface of each finger from the first hand image and the second hand image according to the preset hand texture map style information;
simulate images of a left side and a right side of each finger according to the images of the palm, and the palm surface and the back surface of each finger; and
generate a complete hand texture map by fusing the images of the palm, and the palm surface and the back surface of each finger, as well as the images of the left side and the right side of each finger.

Or, in an optional manner, the plurality of different hand postures further includes: a third hand posture and a fourth hand posture.

The third hand posture includes: bringing a thumb and an index finger together toward a palm when all fingers are naturally spread out, so that the fingers are staggered in sequence in a front-back direction of a side, and one side of the hand is facing the image acquisition device, so that a third hand image captured also includes a side image of each finger on the side.

The fourth hand posture includes: on a basis of the third hand posture, keeping a state of each finger unchanged, and facing the other side of the hand to the image acquisition device, so that a fourth hand image captured also includes a side image of each finger on the other side.

In addition, the hand images may also include: a hand movement video obtained by capturing images during a process of rotating a wrist joint from a first angle to a second angle while keeping a hand posture of five fingers naturally spread out, wherein a difference between the second angle and the first angle is greater than 180 degrees.

Specifically, the hand movement video includes a plurality of image frames corresponding to a process of rotating a part corresponding to a nail from a front view/a side view to the side view/the front view.

At this time, the apparatus may further include:
a model optimization unit, configured to obtain curvature information of the nail from the plurality of image frames to optimize key point parameters of the part corresponding to the nail in the hand 3D model.

Specifically, the target selectable products include manicure products, 3D models corresponding to the target selectable products are parameterized models, the hand 3D basic model includes a nail 3D basic model.

The trial effect display unit can be specifically configured to:
after adjusting key point parameters of a 3D model corresponding to a manicure product according to the nail 3D basic model, match the model to a nail position in the hand 3D model of the target user for display.

Specifically, the nail 3D basic model is established in the following way:
determining information of respective nail contours corresponding to a plurality of fingers from the hand images;
determining, from a plurality of pre-established standard nail basic 3D models, a target standard nail basic 3D model having a degree of similarity with the nail contours satisfying a condition, wherein the standard nail basic 3D models are parameterized models; and
adjusting key point parameters in the target standard nail basic 3D model according to the information of the nail contours to generate the nail 3D basic model, the nail 3D basic model being used to align and fit onto the hand 3D basic model.

In addition, the apparatus may further include:
a candidate posture providing unit, configured to provide candidate placement posture information about the hand 3D model so as to present the display effect of the target selectable product for trial use under a selected placement posture.

In the embodiments of the present disclosure, the apparatus may further include one or more processors, a memory, an input/output interface, and a network interface (not shown in the figure). In the embodiments of the present disclosure, the memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In addition, the embodiments of the present disclosure further provide a computer-readable storage medium on which a computer program is stored, and when the program is executed by a processor, the steps of any one of the methods in the aforementioned method embodiments are implemented.

Furthermore, an electronic device includes:
one or more processors; and
a memory associated with the one or more processors, the memory being configured to store program instructions, wherein the program instructions, when read and executed by the one or more processors, execute the steps of the methods described in any one of the aforementioned method embodiments.

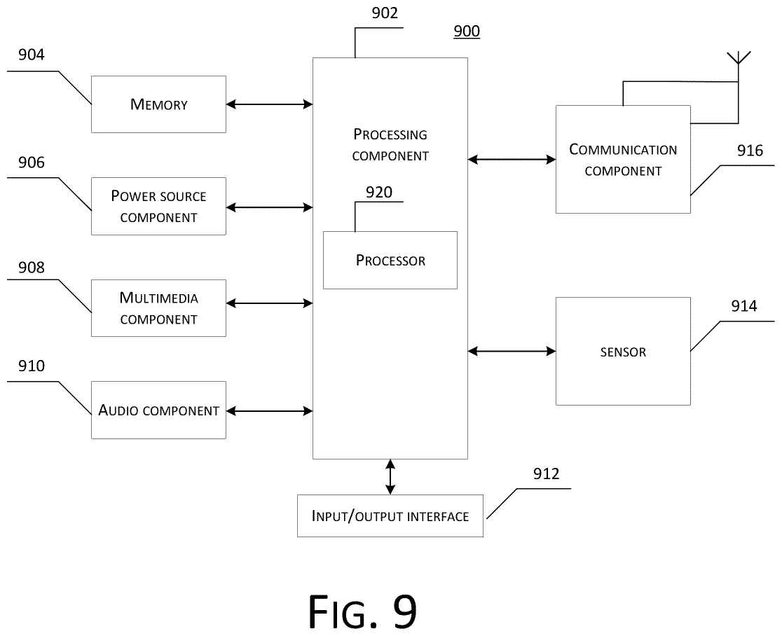

FIG. 9 exemplarily shows an architecture of an electronic device. For example, the device 900 can be a mobile phone, a computer, a digital broadcast terminal, a messaging device, a game console, a tablet device, a medical device, a fitness device, a personal digital assistant, an aircraft, etc.

Referring to FIG. 9, the device 900 may include one or more of the following components: a processing component 902, a memory 904, a power source component 906, a multimedia component 908, an audio component 910, an input/output (I/O) interface 912, a sensor component 914, and a communication component 916.

The processing component 902 generally controls overall operation of the device 900, such as operations associated with display, phone calls, data communications, camera operations, and recording operations. The processing component 902 may include one or more processors 920 to execute instructions to complete all or part of the steps of the methods provided by the technical solutions of the present disclosure. In addition, the processing component 902 may include one or more modules to facilitate interactions between the processing component 902 and other components. For example, the processing component 902 may include a multimedia module to facilitate interactions between the multimedia component 908 and the processing component 902.

The memory 904 is configured to store various types of data to support operations on the device 900. Examples of such data include instructions for any application or method operating on the device 900, contact data, phone book data, messages, pictures, videos, etc. The memory 904 can be implemented by any type of volatile or non-volatile storage device, or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power source component 906 provides power to various components of the device 900. The power source component 906 can include a power management system, one or more power sources, and other components associated with generating, managing, and distributing power for the device 900.

The multimedia component 908 includes a screen that provides an output interface between the device 900 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touching, sliding, and gestures on the touch panel. A touch sensor may not only sense a boundary of a touching or sliding action, but also detect the duration and pressure associated with associated touching or sliding operation. In some embodiments, the multimedia component 908 includes a front camera and/or a rear camera. When the device 900 is in an operating mode, such as a image capture mode or a video mode, the front camera and/or the rear camera may receive external multimedia data. Each front camera and each rear camera may be a fixed optical lens system or have a focal length and optical zoom capability.

The audio component 910 is configured to output and/or input audio signals. For example, the audio component 910 includes a microphone (MIC). When the device 900 is in an operating mode, such as a call mode, a recording mode, and a speech recognition mode, the microphone is configured to receive an external audio signal. The received audio signal can be further stored in the memory 904 or sent via the communication component 916. In some embodiments, the audio component 910 also includes a speaker used for outputting audio signals.

The I/O interface 912 provides an interface between the processing component 902 and peripheral interface modules, such as keyboards, click wheels, buttons, etc. These buttons may include, but are not limited to: a home button, a volume button, a start button, and a lock button.

The sensor component 914 includes one or more sensors used for providing various aspects of status assessment for the device 900. For example, the sensor component 914 can detect an open/closed state of the device 900, relative positioning of components, such as the components being a display and a keypad of the device 900. The sensor component 914 can also detect a position change of the device 900 or a component of the device 900, a presence or absence of user contact with the device 900, an orientation or an acceleration/deceleration of the device 900, and a temperature change of the device 900. The sensor component 914 may include a proximity sensor configured to detect a presence of a nearby object without any physical contact. The sensor component 914 may also include a light sensor, such as a CMOS or CCD image sensor, configured to be used in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the device 900 and other devices. The device 900 can access a wireless network based on a communication standard, such as WiFi, or a mobile communication network such as 2G, 3G, 4G/LTE, 5G, etc. In an exemplary embodiment, the communication component 916 receives a broadcast signal or broadcast-related information from an external broadcast management system via a broadcast channel. In an exemplary embodiment, the communication component 916 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In an exemplary embodiment, the device 900 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as the memory 904 including instructions. The instructions can be executed by the processor 920 of the device 900 to complete the methods provided by the technical solutions of the present disclosure. For example, the non-transitory computer-readable storage medium can be a ROM, a random access memory (RAM), a CD-ROM, a magnetic tape, a floppy disk, an optical data storage device, etc.

As can be known from the description of the above implementation methods, one skilled in the art can clearly understand that the present disclosure can be implemented by means of software plus a necessary general hardware platform. Based on such understanding, the essence of the technical solutions of the present disclosure or the part contributed to the existing technologies can be manifested in a form of a software product. Such computer software product can be stored in a storage medium such as ROM/RAM, a magnetic disk, an optical disk, etc., and includes a number of instructions for enabling a computer device (which can be a personal computer, a server, or a network device, etc.) to execute the methods described in various embodiments of the present disclosure or certain parts of the embodiments.

Each embodiment in the present specification is described in a progressive manner, and the same or similar parts between the embodiments can be referenced to each other. Each embodiment emphasizes on aspects differently from other embodiments. In particular, since systems or system embodiments are basically similar to the method embodiments, a description thereof is relatively simple, and relevant parts can be referenced to the description of parts of the method embodiments. The system and system embodiments described above are merely schematic, wherein the units described as separate components may or may not be physically separated, and the components displayed as units may or may not be physical units, i.e., may be located in one place, or may be distributed over multiple network units. Some or all of the modules may be selected according to actual needs to achieve the purpose of the solutions of the embodiments of the present disclosure. One of ordinary skill in the art can understand and implement thereof without making any creative effort.

The above is a detailed introduction to the methods and electronic devices for displaying effects of virtual trials of products provided by the present disclosure. This article uses specific examples to illustrate the principles and implementation methods of the present disclosure. The description of the above embodiments is only used to help understand the methods and their core ideas of the present disclosure. At the same time, for one skilled in the art, according to the ideas of the present disclosure, there will be changes in specific implementation methods and application scopes. In summary, the content of the present specification should not be understood as limiting the present disclosure.

The present disclosure is further understood using the following clauses.

Clause 1: A method for presenting an effect of a virtual trial of a product, comprising: activating an image acquisition device of a terminal device to obtain hand images of a target user in a plurality of different hand postures in response to a request for a virtual trial of a product initiated by the target user through the terminal device; creating a 3D hand model of the target user according to the hand images; rendering and displaying the hand 3D model in a target interface, and providing information of selectable products; and in response to a selection result of a target selectable product, matching a 3D model corresponding to the target selectable product to a target position in the 3D hand model of the target user for display to show a display effect of virtual trial of the target selectable product through the hand 3D model.

Clause 2: The method of Clause 1, wherein creating the 3D hand model of the target user according to the hand images comprises: creating a 3D basic hand model of the target user according to the hand images, and obtaining a hand texture map of the target user; and attaching the hand texture map to the hand 3D base model to generate the hand 3D model of the target user.

Clause 3: The method of Clause 2, wherein creating the 3D basic hand model of the target user according to the hand images comprises: determining information of a hand contour from the hand images; determining a target standard hand 3D basic model that satisfies a condition of similarity with the hand contour from a plurality of pre-established standard hand 3D basic models, wherein the standard hand 3D basic model is a parameterized model; and adjusting key point parameters in the target standard hand 3D basic model according to the information of the hand contour to generate the hand 3D basic model of the target user.

Clause 4: The method of Clause 2, wherein obtaining the hand texture map of the target user comprises: identifying and segmenting local images of multiple texture map surfaces from the hand images according to preset hand texture mapping style information; and generating a complete hand texture map by fusing the local images of the multiple texture map surfaces.

Clause 5: The method of any one of Clauses 2-4, wherein the hand images comprise: a plurality of hand pictures obtained by respectively collecting the hand images of the target user in the plurality of different hand postures.

Clause 6: The method of Clause 5, wherein the plurality of different hand postures includes a first hand posture and a second hand posture, the first hand posture and the second hand posture correspond to a palm and a back of the hand facing the image acquisition device respectively when each finger is naturally extended, so that the first hand image and second hand image that are captured simultaneously include an image of the palm, and images of a palm surface and a back surface of each finger.

Clause 7: The method of Clause 6, wherein obtaining the hand texture map of the target user comprises: identifying and segmenting images of the palm, and the palm surface and the back surface of each finger from the first hand image and the second hand image according to the preset hand texture map style information; simulating images of a left side and a right side of each finger according to the images of the palm, and the palm surface and the back surface of each finger; and generating a complete hand texture map by fusing the images of the palm, and the palm surface and the back surface of each finger, as well as the images of the left side and the right side of each finger.

Clause 8: The method of Clause 6, wherein: the plurality of different hand postures further comprises: a third hand posture and a fourth hand posture; the third hand posture comprises: bringing a thumb and an index finger together toward a palm when all fingers are naturally spread out, so that the fingers are staggered in sequence in a front-back direction of a side, and one side of the hand is facing the image acquisition device, so that a third hand image captured also includes a side image of each finger on the side; and the fourth hand posture comprises: on a basis of the third hand posture, keeping a state of each finger unchanged, and facing the other side of the hand to the image acquisition device, so that a fourth hand image captured also includes a side image of each finger on the other side.

Clause 9: The method of any one of Clauses 2-4, wherein the hand images comprise: a hand movement video obtained by capturing images during a process of rotating a wrist joint from a first angle to a second angle while keeping a hand posture of five fingers naturally spread out, wherein a difference between the second angle and the first angle is greater than 180 degrees.

Clause 10: The method of Clause 9, wherein: the hand movement video comprises a plurality of image frames corresponding to a process of rotating a part corresponding to a nail from a front view/a side view to the side view/the front view; and the method further comprises: obtaining curvature information of the nail from the plurality of image frames to optimize key point parameters of the part corresponding to the nail in the hand 3D model.

Clause 11: The method of any one of Clauses 2-4, wherein: the target selectable products comprise manicure products, 3D models corresponding to the target selectable products are parameterized models, the hand 3D basic model includes a nail 3D basic model; and matching the 3D model corresponding to the target selectable product to the target position in the 3D hand model of the target user for display comprises: after adjusting key point parameters of a 3D model corresponding to a manicure product according to the nail 3D basic model, matching the model to a nail position in the hand 3D model of the target user for display.

Clause 12: The method of Clause 11, wherein creating the nail 3D basic model in the following way: determining information of respective nail contours corresponding to a plurality of fingers from the hand images; determining, from a plurality of pre-established standard nail basic 3D models, a target standard nail basic 3D model having a degree of similarity with the nail contours satisfying a condition, wherein the standard nail basic 3D models are parameterized models; and adjusting key point parameters in the target standard nail basic 3D model according to the information of the nail contours to generate the nail 3D basic model, the nail 3D basic model being used to align and fit onto the hand 3D basic model.

Clause 13: A computer-readable storage medium stores a computer program, which, when executed by a processor, implements the method of any one of Clauses 1-12.

Clause 14: An electronic device comprising: one or more processors; and a memory associated with the one or more processors, the memory being configured to store program instructions, wherein the program instructions, when read and executed by the one or more processors, execute the method of any of one of Clauses 1-12.

What is claimed is:

1. A method comprising:
activating an image acquisition device of a terminal device to obtain hand images of a target user in a plurality of different hand postures in response to a request for a virtual trial of a product initiated by the target user through the terminal device;
creating a 3D hand model of the target user according to the hand images;
rendering and displaying the hand 3D model in a target interface, and providing information of selectable products; and
in response to a selection result of a target selectable product, matching a 3D model corresponding to the target selectable product to a target position in the 3D hand model of the target user for display to show a display effect of virtual trial of the target selectable product through the hand 3D model.

2. The method of claim 1, wherein creating the 3D hand model of the target user according to the hand images comprises:
creating a 3D basic hand model of the target user according to the hand images, and obtaining a hand texture map of the target user; and
attaching the hand texture map to the hand 3D base model to generate the hand 3D model of the target user.

3. The method of claim 2, wherein creating the 3D basic hand model of the target user according to the hand images comprises:
determining information of a hand contour from the hand images;
determining a target standard hand 3D basic model that satisfies a condition of similarity with the hand contour from a plurality of pre-established standard hand 3D basic models, wherein the standard hand 3D basic model is a parameterized model; and
adjusting key point parameters in the target standard hand 3D basic model according to the information of the hand contour to generate the hand 3D basic model of the target user.

4. The method of claim 2, wherein obtaining the hand texture map of the target user comprises:
identifying and segmenting local images of multiple texture map surfaces from the hand images according to preset hand texture mapping style information; and
generating a complete hand texture map by fusing the local images of the multiple texture map surfaces.

5. The method of claim 2, wherein the hand images comprise: a plurality of hand pictures obtained by respectively collecting the hand images of the target user in the plurality of different hand postures.

6. The method of claim 5, wherein the plurality of different hand postures includes a first hand posture and a second hand posture, the first hand posture and the second hand posture correspond to a palm and a back of the hand facing the image acquisition device respectively when each finger is naturally extended, so that the first hand image and second hand image that are captured simultaneously include an image of the palm, and images of a palm surface and a back surface of each finger.

7. The method of claim 6, wherein obtaining the hand texture map of the target user comprises:
identifying and segmenting images of the palm, and the palm surface and the back surface of each finger from the first hand image and the second hand image according to the preset hand texture map style information;
simulating images of a left side and a right side of each finger according to the images of the palm, and the palm surface and the back surface of each finger; and
generating a complete hand texture map by fusing the images of the palm, and the palm surface and the back surface of each finger, as well as the images of the left side and the right side of each finger.

8. The method of claim 6, wherein:
the plurality of different hand postures further comprises: a third hand posture and a fourth hand posture;
the third hand posture comprises: bringing a thumb and an index finger together toward a palm when all fingers are naturally spread out, so that the fingers are staggered in sequence in a front-back direction of a side, and one side of the hand is facing the image acquisition device, so that a third hand image captured also includes a side image of each finger on the side; and
the fourth hand posture comprises: on a basis of the third hand posture, keeping a state of each finger unchanged, and facing the other side of the hand to the image acquisition device, so that a fourth hand image captured also includes a side image of each finger on the other side.

9. The method of claim 2, wherein the hand images comprise: a hand movement video obtained by capturing images during a process of rotating a wrist joint from a first angle to a second angle while keeping a hand posture of five fingers naturally spread out, wherein a difference between the second angle and the first angle is greater than 180 degrees.

10. One or more non-transitory media storing executable instructions that, when executed by one or more processors, cause the one or more processors to perform operations comprising:
activating an image acquisition device of a terminal device to obtain hand images of a target user in a plurality of different hand postures in response to a request for a virtual trial of a product initiated by the target user through the terminal device;
creating a 3D hand model of the target user according to the hand images;
rendering and displaying the hand 3D model in a target interface, and providing information of selectable products; and
in response to a selection result of a target selectable product, matching a 3D model corresponding to the target selectable product to a target position in the 3D hand model of the target user for display to show a display effect of virtual trial of the target selectable product through the hand 3D model.

11. The one or more non-transitory media of claim 10, wherein creating the 3D hand model of the target user according to the hand images comprises:
creating a 3D basic hand model of the target user according to the hand images, and obtaining a hand texture map of the target user; and
attaching the hand texture map to the hand 3D base model to generate the hand 3D model of the target user.

12. The one or more non-transitory media of claim 11, wherein creating the 3D basic hand model of the target user according to the hand images comprises:
determining information of a hand contour from the hand images;
determining a target standard hand 3D basic model that satisfies a condition of similarity with the hand contour from a plurality of pre-established standard hand 3D basic models, wherein the standard hand 3D basic model is a parameterized model; and
adjusting key point parameters in the target standard hand 3D basic model according to the information of the hand contour to generate the hand 3D basic model of the target user.

13. The one or more non-transitory media of claim 11, wherein obtaining the hand texture map of the target user comprises:
identifying and segmenting local images of multiple texture map surfaces from the hand images according to preset hand texture mapping style information; and
generating a complete hand texture map by fusing the local images of the multiple texture map surfaces.

14. The one or more non-transitory media of claim 11, wherein the hand images comprise: a plurality of hand pictures obtained by respectively collecting the hand images of the target user in the plurality of different hand postures.

15. The one or more non-transitory media of claim 14, wherein the plurality of different hand postures includes a first hand posture and a second hand posture, the first hand posture and the second hand posture correspond to a palm and a back of the hand facing the image acquisition device respectively when each finger is naturally extended, so that the first hand image and second hand image that are captured simultaneously include an image of the palm, and images of a palm surface and a back surface of each finger.

16. The one or more non-transitory media of claim 15, wherein obtaining the hand texture map of the target user comprises:
identifying and segmenting images of the palm, and the palm surface and the back surface of each finger from the first hand image and the second hand image according to the preset hand texture map style information;
simulating images of a left side and a right side of each finger according to the images of the palm, and the palm surface and the back surface of each finger; and
generating a complete hand texture map by fusing the images of the palm, and the palm surface and the back surface of each finger, as well as the images of the left side and the right side of each finger.

17. The one or more non-transitory media of claim 15, wherein:
the plurality of different hand postures further comprises: a third hand posture and a fourth hand posture;
the third hand posture comprises: bringing a thumb and an index finger together toward a palm when all fingers are naturally spread out, so that the fingers are staggered in sequence in a front-back direction of a side, and one side of the hand is facing the image acquisition device, so that a third hand image captured also includes a side image of each finger on the side; and
the fourth hand posture comprises: on a basis of the third hand posture, keeping a state of each finger unchanged, and facing the other side of the hand to the image acquisition device, so that a fourth hand image captured also includes a side image of each finger on the other side.

18. The one or more non-transitory media of claim 11, wherein the hand images comprise: a hand movement video obtained by capturing images during a process of rotating a wrist joint from a first angle to a second angle while keeping a hand posture of five fingers naturally spread out, wherein a difference between the second angle and the first angle is greater than 180 degrees.

19. An apparatus comprising:
one or more processors;
memory storing executable instructions that, when executed by the one or more processors, cause the one or more processors to perform operations comprising:
activating an image acquisition device of a terminal device to obtain hand images of a target user in a plurality of different hand postures in response to a request for a virtual trial of a product initiated by the target user through the terminal device;
creating a 3D hand model of the target user according to the hand images;
rendering and displaying the hand 3D model in a target interface, and providing information of selectable products; and
in response to a selection result of a target selectable product, matching a 3D model corresponding to the target selectable product to a target position in the 3D hand model of the target user for display to show a display effect of virtual trial of the target selectable product through the hand 3D model.

20. The apparatus of claim 19, wherein creating the 3D hand model of the target user according to the hand images comprises:
creating a 3D basic hand model of the target user according to the hand images, and obtaining a hand texture map of the target user; and
attaching the hand texture map to the hand 3D base model to generate the hand 3D model of the target user.
